(19) United States
(12) Patent Application Publication
(10) Pub. No.: US 2007/0056692 A1
(43) Pub. Date: Mar. 15, 2007

(54) Angle adjusting device for blind slats

(75) Inventors: Ming Nien, Taichung (TW); Wen Yu che, Taichung (TW); Chang chin Yao, Taichung (TW)

Correspondence Address: TROXELL LAW OFFICE PLLC, SUITE 1404, 5205 LEESBURG PIKE, FALLS CHURCH, VA, 22041, US

(73) Assignee: Nien Made Enterprise Co., Ltd.

(21) Appl. No.: 11/225,004

(22) Filed: Sep. 14, 2005

(51) Int. Cl. E06B 9/30

(52) U.S. Cl. 160/168.1 R

(57) ABSTRACT

An angle adjusting device for blind slats includes a base fixed in an upper elongate case, a winding shaft pivotally connected to the base and rotatable clockwise or counterclockwise by a controlling member, and a string wound on the winding shaft having two ends extending out of a first end of the base. Then, the two ends of the string are connected respectively with two hanging ropes of a support rope unit so that the angle-adjusting device may be handled for easily adjusting the angle of the blind slats.

### BACKGROUND OF THE INVENTION

1. Field of the Invention

This invention relates to a blind, particularly to an angle-adjusting device for blind slats easily assembled with its cost lowered substantially.

2. Description of the Prior Art

Conventional blinds, especially Venetian ones, are generally provided with an angle adjusting device fixed in an upper elongate case of blind slats. The conventional angle adjusting device is composed of a base, a winding shaft pivotally deposited on the base, two pulling ropes or a control rod for rotating the winding shaft clockwise or counterclockwise, a rotating shaft fixed with the winding shaft and extending through and fixed with plural stabilizing members that are respectively connected with the upper ends of the two hanging ropes of the support rope set. Thus when a user pulls one of the pulling ropes, the winding shaft and the rotating shaft together with the stabilizing members synchronously rotate clockwise or counterclockwise, with one of the hanging ropes fixed with the stabilizing members may be raised up and with the other hanging rope naturally falling down to change the angle of each slat to the preset side.

However, the conventional angle adjusting device has many components, such as the base, the winding shaft, the rotating shaft, the plural shaft bases and the plural fixing members, complicating its structure and subsequently heighten its cost.

### SUMMARY OF THE INVENTION

The feature of the invention is a base fixed in an upper elongate case of a blind, a winding shaft pivotally connected with the base and rotated by a rotation control member to rotate clockwise or counterclockwise, and a string wound on the winding shaft and having two ends extending out of a first end side of the base and connected with two hanging ropes of a support rope for blind slats. Then the angle-adjusting device can be handled for adjusting the angle of the blind slats with ease.

### BRIEF DESCRIPTION OF DRAWINGS

This invention will be better understood by referring to the accompanying drawings, wherein.;

FIG. 1 is a perspective view of a blind provided with a first embodiment of an angle-adjusting device for blind slats in the present invention;

FIG. 2 is a partial perspective view of the first embodiment of an angle-adjusting device for blind slats combined with a rope-pulling device in the present invention;

FIG. 3 is a partial exploded perspective view of the first embodiment of an angle adjusting device for blind slats and the rope-pulling device in the present invention;

FIG. 4 is a perspective view of the first embodiment of an angle adjusting device for blind slats in the present invention, showing it under an adjusting condition; and,

FIG. 5 is a perspective view of a second embodiment of an angle-adjusting device for blind slats in the present invention.

### DETAILED DESCRIPTION OF THE PREFERRED EMBODIMENTS

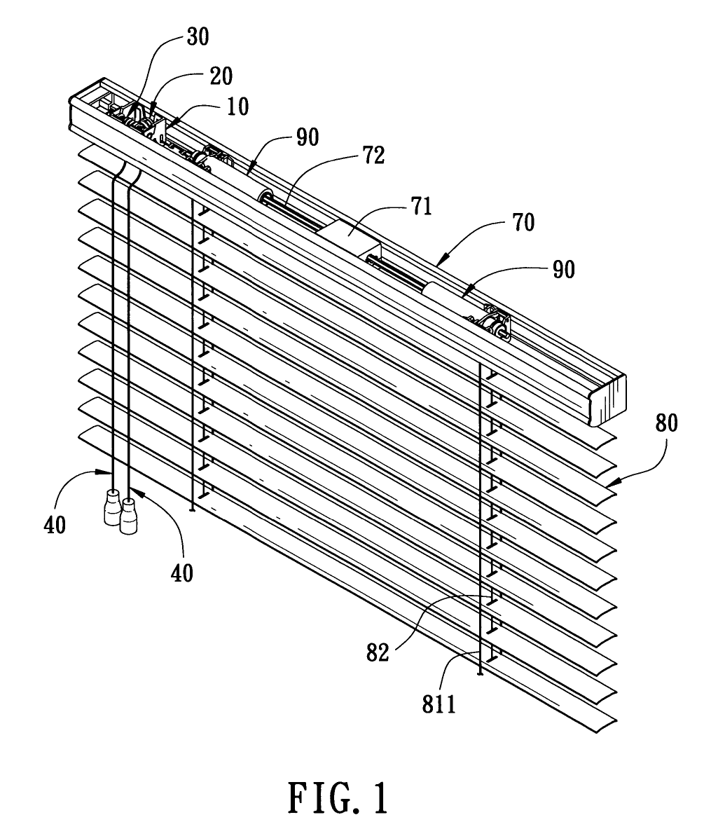

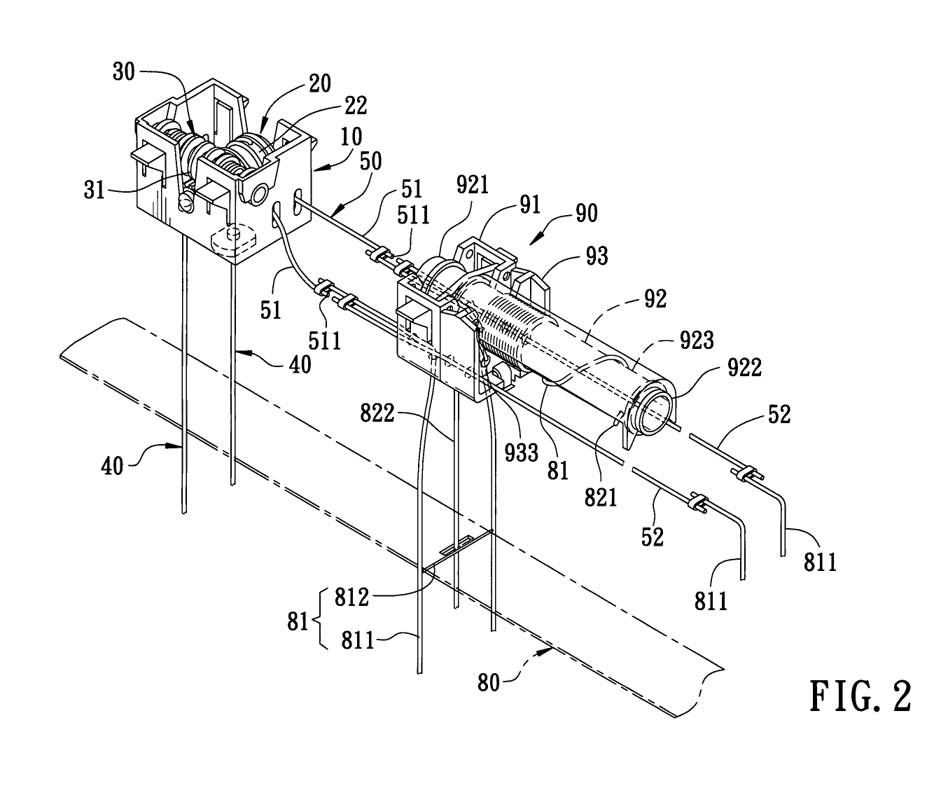

A first embodiment of an angle adjusting device for blind slats in the present invention, specially applied to a blind with no pulling ropes and fixed in an upper elongate case 70 for moving up and down a rear hanging rope 811 of a left and a right side support rope unit 81 so as to adjust the angle of each slat 80 supported by a connecting rope 812 of the support rope unit 81. The angle adjusting device, as shown in FIGS. 1, 2 and 3, includes a base 10, a winding shaft 20, a transmitting rod 30, two pulling ropes 40, and a winding string 50.

The base 10 is fixed in one side of the upper elongate case 70.

The winding shaft 20 is pivotally connected with the base 10, composed of a worm gear 21 on one side and a winding stage 22 on the other side.

The transmitting rod 30 is pivotally connected to the base 10, composed of a worm 31 engaging the worm gear 21 , rotating the winding shaft 20 clockwise or counterclockwise, and two winding members 32 separated by the worm 31.

The two pulling ropes 40 are respectively wound on the two winding stage 32 of the transmitting rod 30, for rotating respectively the transmitting rod 30 clockwise or counterclockwise.

The winding string 50 has a pulling member 51 and a connecting members 52 severed from the pulling member 51, and the pulling member 51 winds around the winding stage 22, having a free end 511 extending out of the base 10 and then connected with a hanging rope 811 of the support rope unit 81. The connecting member 52 is made of a metal wire of low flexibility, having one end connected with the end of the hanging rope 811 connected with the free end 511. However, the connecting member 52 can also be made to extend from the free end 511 of the pulling member 51.

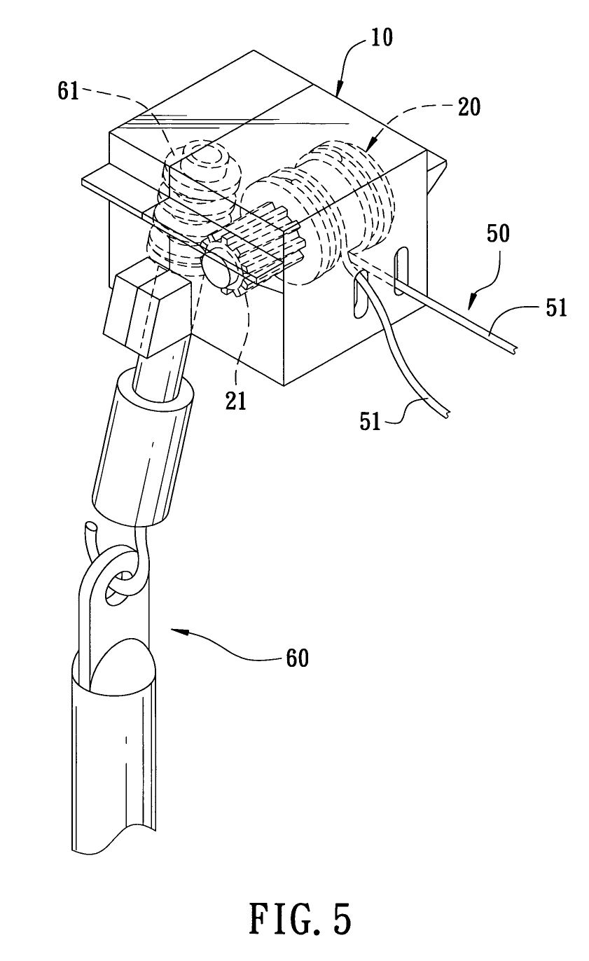

Next, FIG. 5 shows a second embodiment of an angle adjusting device for blind slats in the invention, which has almost the same structure as the first one, except an controlling rod 60 used instead of the transmitting rod 30 and the pulling ropes 40, pivotally connected slantingly to the base 10, having a worm 61 at an upper end engaging with the worm gear 21 of the winding shaft 20. Then, when the controlling rod 60 is rotated, the winding shaft 20 is rotated clockwise or counterclockwise.

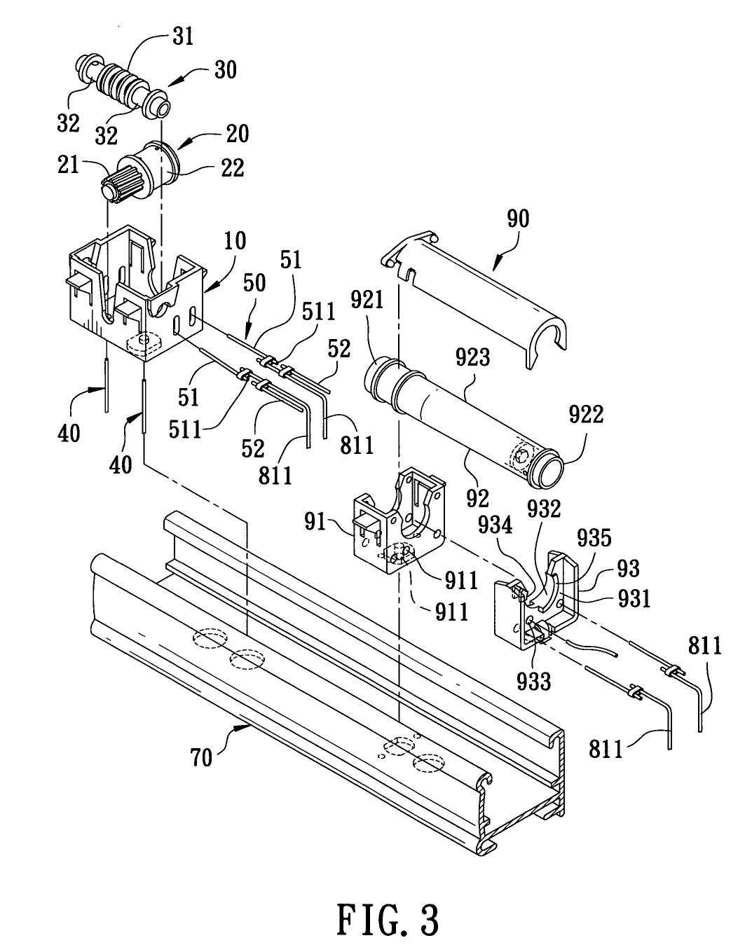

Further, referring to FIG. 3, two rope winding devices 90 are additionally provided to match with the angle adjusting device for blind slats, fixed at two sides of the upper elongate case 70, possible to wind up the pulling rope 82 of each slat 80 by means of an elastic mechanism 71 located in the intermediate portion of the upper elongate case 70, so the slats 80 may be raised up or lowered down. The rope-winding device 90 is composed of a shaft base 91, a winding shaft 92, and a rope guider 93. The shaft base 91 is fixed in the upper elongate case 70, having a rope hole 911 formed in a bottom for the pulling rope 82 to pass through, and the winding shaft 92 has a first end 921 fitted in the shaft base 91, and a second end 922 for a first end 821 of the puling rope 82 to be fixed thereon, an outer tapered surface 923 from the first end 921 to the second end 922 for the puling rope 82 to be wound around thereon and guided to shift toward the second end 922. The rope guider 93 is fixed in the upper elongate case 70, located at an outer side next to the shaft base 91 , having a vertical wall 931 in the center, a concave groove 932 formed centrally in the vertical wall 931 for the winding shaft 92 to rest therein with a proper gap. Further, two rope holes 933 are provided in the vertical wall 931 near and below the concave groove 932 for the second end 822 of the pulling rope 82 to pass through after passing through the rope hole 911 of the shaft base 91. Further on the outer side of the concave groove 932 of the vertical wall 931 are provided a first push block 934 and a second push block 935, and the first push block 934 has a flat upper surface and the second push block 935 has an inclined surface rising upward. The first and the second push block 934 and 935 guide the pulling rope 82 to be wound and also shift gradually toward the second end 922 of the wind shaft 92, with every round of the wound pulling rope 82 contacting with each other closely.

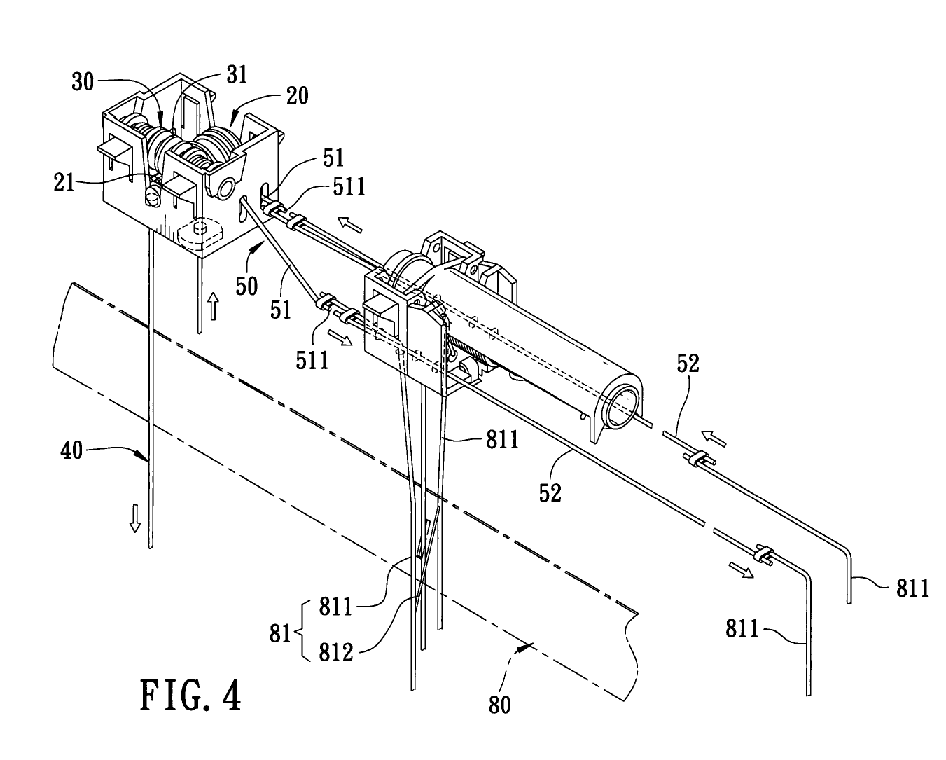

Next, referring to FIG. 4, if a user wants to adjust the angle of the slats 80, he/she pulls down one of the pulling ropes 40, which then rotates the transmitting rod 30 clockwise or counterclockwise. Then the worm 31 engaging the worm gear 21 rotates the worm gear 21 in the same direction, and accordingly the free end 511 of the pulling member 51 of the winding string 50 wound on the winding shaft 50 may be pulled inward so that one of the two hanging ropes 811 may be pulled up, and the other hanging rope 811 of the same support rope set 81 connected with the connected string 812 may also be pulled up synchronously by the connecting member 52. Further, the free end 511 of the other pulling member 51 of the winding string 51 is released outward, and the other hanging rope 811 of the of the support rope set 81 will automatically fall down for the corresponding distance owing to the weight of each slat 80 connected with the connecting string 812. Therefore, each slat 80 can be adjusted in its angle, with one of the lengthwise side connected with one of the hanging rope 811 moved up and with the other lengthwise side connected with the other hanging rope 811 falling down. And it should be mentioned that the angle adjusting device for blind slats is composed with the base 10 and the winding shaft 20, to add only the winding string 50, effectively simplified in its structure and subsequently minimizing its manufacturing and assembling cost. Moreover, the connecting stages 52 are made of a metal of low flexibility, so they are not subject to lengthening by repeated pulling movement, or disfiguring or slacking, and ensuring accurate up-and-down movement of the hanging ropes 811 of the support rope set 81. Then the slats 80 may incline in their angles correctly, with the angle adjusting function kept accurate to maintain the stability and aesthetic appearance of the blind.

While the preferred embodiments of the invention have been described above, it will be recognized and understood that various modifications may be made therein and the appended claims are intended to cover all such modifications that may fall within the spirit and scope of the invention.

What is claimed is:

1. An angle adjusting device for blind slats installed in an upper elongate case of a blind and moving up and down a front and rear hanging rope of a first and a second support rope unit for adjusting an inclining angle of said slots, said angle adjusting device comprising:
a base fixed in one side of said upper elongate case;
a winding shaft pivotally connected to said base;
a controlling member for controlling said winding shaft clockwise or counterclockwise;
a winding string wound on said winding shaft and having two ends extending out of said base, said two ends respectively connected with said two hanging ropes of said first and said second support rope units.

2. The angle adjusting device as claimed in claim 1, wherein said controlling member is two pull ropes respectively pulled to rotate said winding shaft clockwise or counterclockwise.

3. The angle adjusting device as claimed in claim 1, wherein said controlling member is a controlling rod.

4. The angle adjusting device as claimed in claim 1, wherein said winding string consists of a pulling stage and two connecting stages, said pulling stage is wound on said winding shaft and has two free ends passing out of said base, said two free ends connected with said two hanging ropes of said first support rope unit, said two connecting stages respectively connected to said two free ends of said pulling stage and also connected to said two hanging ropes of said second support rope unit.

5. The angle adjusting device as claimed in claim 4, wherein said two connecting stages of said winding string are made of a string having little flexibility.

6. The angle adjusting device as claimed in claim 4, wherein said two connecting stages of said winding string are made of a metal wire.

7. The angle adjusting device as claimed in claim 1, wherein said winding shaft is composed of a winding stage and a worm gear, said winding stage is for said winding string to wind thereon, and a transmitting rod is pivotally connected with said base, said transmitting rod is formed with a worm in its intermediate portion and engages said worm gear of said winding shaft, said transmitting rod further has two winding stages respectively at two sides of said worm for said two pulling ropes functioning as said controlling member to wind thereon, and said transmitting rod are pulled by said two pulling ropes to rotate clockwise or counterclockwise.

8. The angle adjusting device as claimed in claim 1, wherein said winding shaft is provided with a winding stage and a worm gear, said winding stage is for said winding string to be wound thereon, a controlling rod functioning as said control member is pivotally connected with said base, said controlling rod is provide with a worm at one end to engage said worm gear of said winding shaft for transmitting.

9. The angle adjusting device as claimed in claim 1, wherein two rope winding devices further are provided respectively in two sides of said upper elongate case, rotated by a rotating shaft driven by an elastic mechanism fixed in an intermediate portion of said upper elongate case, so said rope winding devices wind up said pulling ropes of said slats for raising up or releasing down said slats.

10. The angle adjusting device as claimed in claim 9, wherein said rope winding device comprises:
a shaft base fixed in said upper elongate case and having a rope hole bored in a bottom and a sidewall for a rope to pass through;
a winding shaft combined on a first end of said shaft base, having a second end in an outer end for affixing a first end of said rope, a tapered outward surface formed from said first end to said second end for said pulling rope to be wound thereon gradually and at the same shifting gradually from said first end to said second end orderly; and,
a rope guider fixed in said upper elongate case and separated from said shaft base, said rope guider further having a vertical wall, said vertical wall provided with a concave groove in its upper center portion, said winding shaft placed in said concave groove with a preset gap, a rope hole bored in said vertical wall near said concave groove for said second end of said pulling rope passing through a sidewall of said shaft base to pass through, at least a push block provided on a sidewall of said vertical wall where said second end of the said winding shaft is located, said push block guiding said second end of said pulling rope coming out of said rope hole of said vertical hole to move forward and gradually wound on said tapered surface to said second end of said winding shaft during winding process so that said pulling rope may be wound with every round closely contacting with each other.
